(19) United States
(12) Patent Application Publication
(10) Pub. No.: US 2019/0290409 A1
(43) Pub. Date: Sep. 26, 2019

(54) TOOTH CLEANING DEVICE

(71) Applicant: Howard Marcus, Fremont, CA (US)

(72) Inventor: Howard Marcus, Fremont, CA (US)

(21) Appl. No.: 16/364,111

(22) Filed: Mar. 25, 2019

Related U.S. Application Data
(60) Provisional application No. 62/647,514, filed on Mar. 23, 2018.

(51) Int. Cl. A61C 17/22

(52) U.S. Cl. CPC A61C 17/227; A46B 5/0095; A61C 17/222

(57) ABSTRACT

An electric tooth cleaning device; the electric tooth cleaning device includes a toothbrush, a toothbrush-actuator, a cartridge-compartment, a cartridge-door, a conduit, at least one cartridge, a cartridge-actuator, a user-interface, and at least one power-source. The electric tooth cleaning device provides users with an improved toothbrush capable of applying toothpaste to the bristles using an internal cartridge.

### CROSS REFERENCE TO RELATED APPLICATION

The present application is related to and claims priority to U.S. Provisional Patent Application No. 62/647,514 filed Mar. 23, 2018 which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. FIELD OF THE INVENTION

The present invention relates generally to the field of toothcare and more specifically relates to a toothcare composition dispensing brush.

### 2. DESCRIPTION OF RELATED ART

Applying toothpaste to a toothbrush each time the brush is used can be annoying and frustrating. Some people may spend time each morning looking for a toothpaste container. It may be difficult to squeeze remaining toothpaste out of a container, leading to individuals simply throwing away the container and essentially wasting toothpaste. A suitable solution is desired.

U.S. Pat. No. 5,066,155 to Philip H. English relates to a toothbrush and paste dispenser. The described toothbrush and paste dispenser includes a toothbrush and toothpaste dispenser unit comprising a brush head with a longitudinally extending toothpaste receiving and dispensing opening provided therein, and a disposable toothpaste receiver and dispenser cartridge which engages the brush head and connects to the opening in the brush head. A dispensing piston, and a drive screw are present with the cartridge while a drive member for the screw is present and it includes a one way rotary drive means. The cartridge has an outer sleeve which forms a handle for the dispenser unit. The unit has a single wall thickness, i.e. the outer sleeve of the cartridge, in the cartridge portion of the unit.

### BRIEF SUMMARY OF THE INVENTION

In view of the foregoing disadvantages inherent in the known toothcare art, the present disclosure provides a novel tooth cleaning device. The general purpose of the present disclosure, which will be described subsequently in greater detail, is to provide an improved toothbrush capable of applying toothpaste to bristles using an internal cartridge.

An electric tooth cleaning device is disclosed herein. The electric tooth cleaning device includes a toothbrush which may include a housing having an inner-capacity defined by an outer-shell, the housing further may include a handle-end and a brush-end and the brush-end may include a plurality of dispensing apertures and a plurality of bristles thereon. Further, a toothbrush-actuator may be disposed within the inner-capacity of the housing, the tooth-brush actuator being connected to the brush-end and configured to selectively move the brush-end. A cartridge-compartment may be disposed within the inner-capacity of the housing.

Further, a cartridge-door may be located on the outer-shell of the housing, the cartridge-door may be configured to provide access to the cartridge-compartment. A conduit may be disposed within the inner-capacity and may be connected to the dispensing apertures at a first conduit-end. In addition, at least one cartridge may be configured for removable placement into the cartridge-compartment and include a cartridge inner-capacity defined by a cartridge-shell and a toothcare-composition housed within the cartridge inner-capacity. The at least one cartridge may further include a first cartridge-end and a second cartridge-end and the first cartridge-end may be configured for attachment to the conduit at a second conduit-end.

A cartridge-actuator may be disposed within inner-capacity of the housing, the cartridge-actuator may include a cartridge-plunger being configured to manipulate the second cartridge-end to dispense at least one a portion of the toothcare-composition from the first cartridge-end into the conduit. In addition, a user-interface may be located on the outer-shell of the housing, the user-interface being configured to selectively activate at least one of the toothbrush-actuator and the cartridge-actuator. Further, at least one power-source may be disposed within the housing, the at least one power source configured to supply power to the toothbrush-actuator and the cartridge-actuator.

A method of using electric tooth cleaning device is also disclosed herein. The method of using electric tooth cleaning device may comprise the steps of: providing the electric tooth cleaning device as above; using the user-interface to activate the cartridge-actuator to dispense the at least the portion of the toothcare-composition through the dispensing-apertures; using the user-interface to activate the toothbrush-actuator to move the brush-end; and applying the at least the portion of the toothcare-composition to teeth of a user via the plurality of bristles.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a tooth cleaning device, constructed and operative according to the teachings of the present disclosure.

FIG. 1 is a front-top perspective view of the electric tooth cleaning device during an ‘in-use’ condition, according to an embodiment of the disclosure.

FIG. 2 is a side-top perspective view of the electric tooth cleaning device of FIG. 1, according to an embodiment of the present disclosure.

FIG. 3 is a side perspective view of the electric tooth cleaning device of FIG. 1, according to an embodiment of the present disclosure.

FIG. 4 is a side perspective view of the electric tooth cleaning device of FIG. 1, according to an embodiment of the present disclosure.

FIG. 5 is a front-side perspective view of the electric tooth cleaning device of FIG. 1, according to an embodiment of the present disclosure.

FIG. 6 is a flow diagram illustrating a method of use for the electric tooth cleaning device, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to toothcare and more particularly to a tooth cleaning device as used to improve the toothcare composition dispensing brush.

Generally, disclosed is an electric toothbrush with toothcare composition dispensing means. The toothbrush may include interchange rechargeable batteries within the handle in order to power the internal cartridge when applying toothpaste to the bristles. The electric toothbrush may enable individuals to insert different types and flavors of toothpaste into the brush for application to the bristles, effectively eliminating the need to locate a separate container of toothpaste when trying to brush teeth. Further, the electric toothbrush may prevent users from wasting toothpaste, ensuring all internal contents of a toothpaste composition cartridge are consumed and applied to the bristles.

The electric toothbrush may include an internal toothpaste cartridge designed to apply toothpaste directly to the bristles. The toothbrush may contain an open interior capable of receiving a cartridge and a pair of batteries. A channel from the cartridge may run along the length of the toothbrush handle and up into the bristles. Batteries may provide power to the cartridge such that, when the toothbrush is activated, the cartridge may automatically place toothpaste on the bristles.

Each cartridge and battery may be interchanged as needed. The cartridges may contain numerous types and flavors of toothpaste. The cartridge may offer a simple and convenient way for both children and adults to apply toothpaste to their brush bristles. In addition, each toothbrush head may be detached and replaced as needed. The electric toothbrush may be constructed using plastic and other suitable materials. The toothbrush may be available in a standard size capable of accommodating all user needs and preferences. Exact size, measurement, construction, and design specifications may vary upon manufacturing.

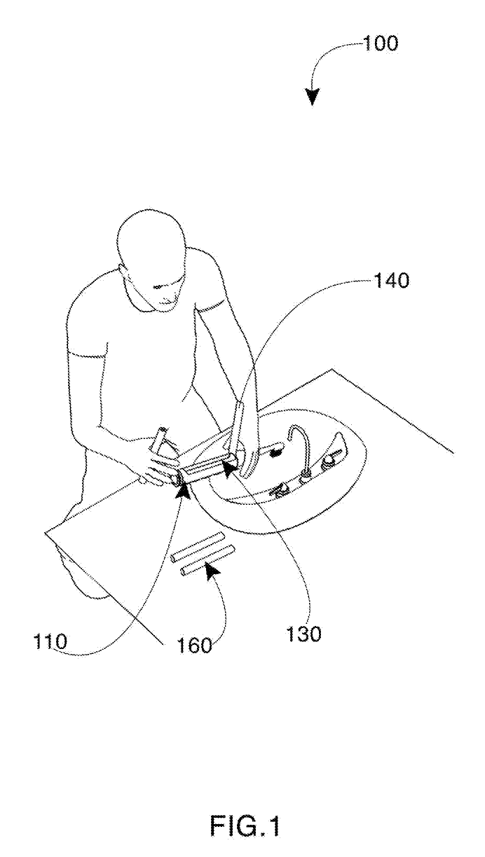

Referring now more specifically to the drawings by numerals of reference, there is shown in FIGS. 1-5, various views of an electric tooth cleaning device 100.

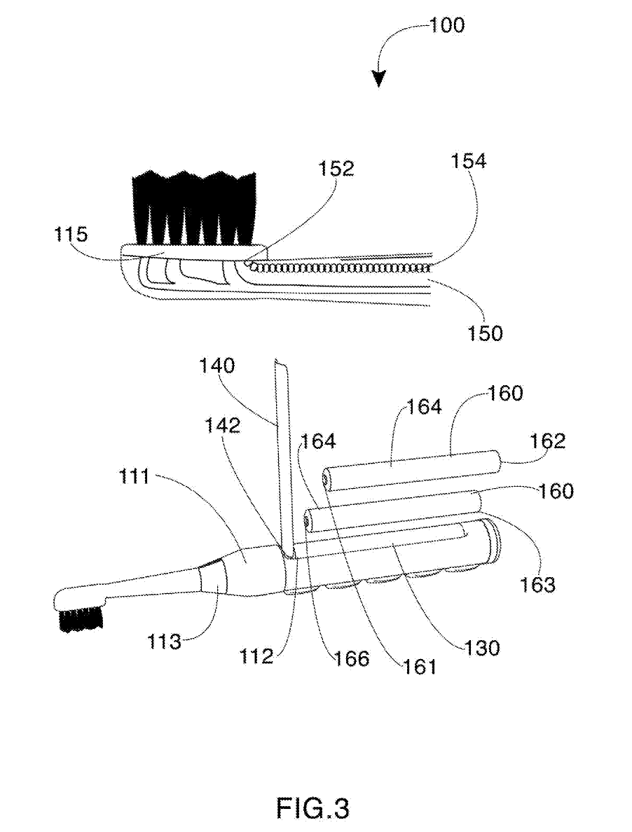

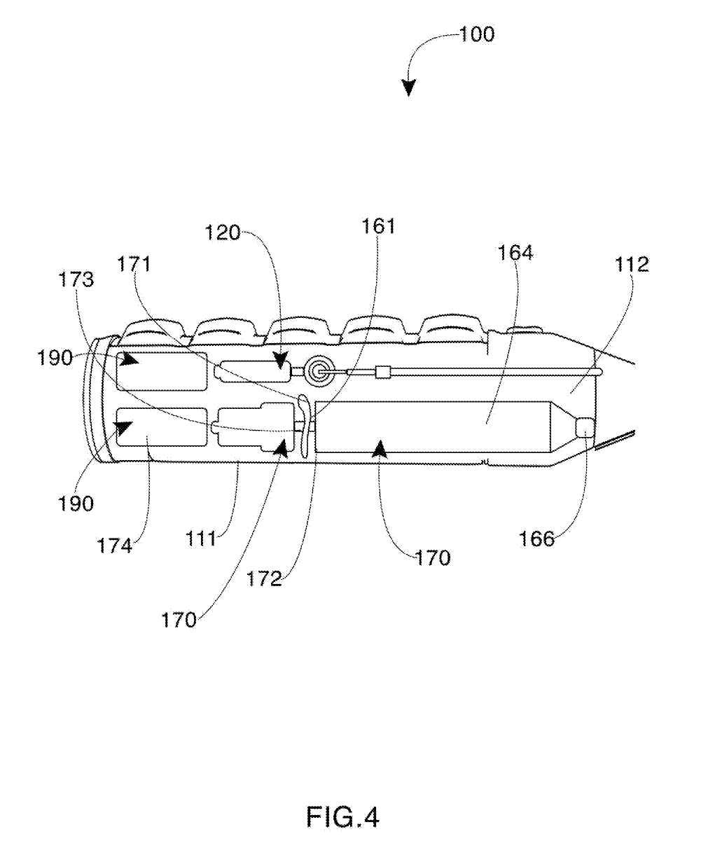

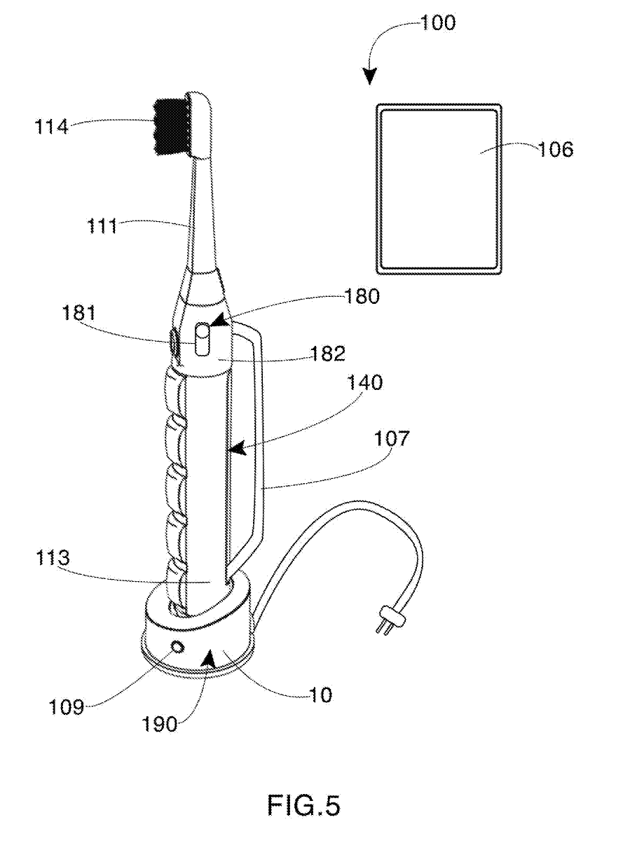

FIG. 1 shows an electric tooth cleaning device 100 during an ‘in-use’ condition, according to an embodiment of the present disclosure. As illustrated, the electric tooth cleaning device 100 may include a toothbrush 110, a toothbrush-actuator 120 (FIG. 4), a cartridge-compartment 130, a cartridge-door 140, a conduit 150 (FIG. 3), at least one cartridge 160, a cartridge-actuator 170 (FIG. 4), a user-interface 180 (FIG. 5), and at least one power-source 190 (FIG. 4).

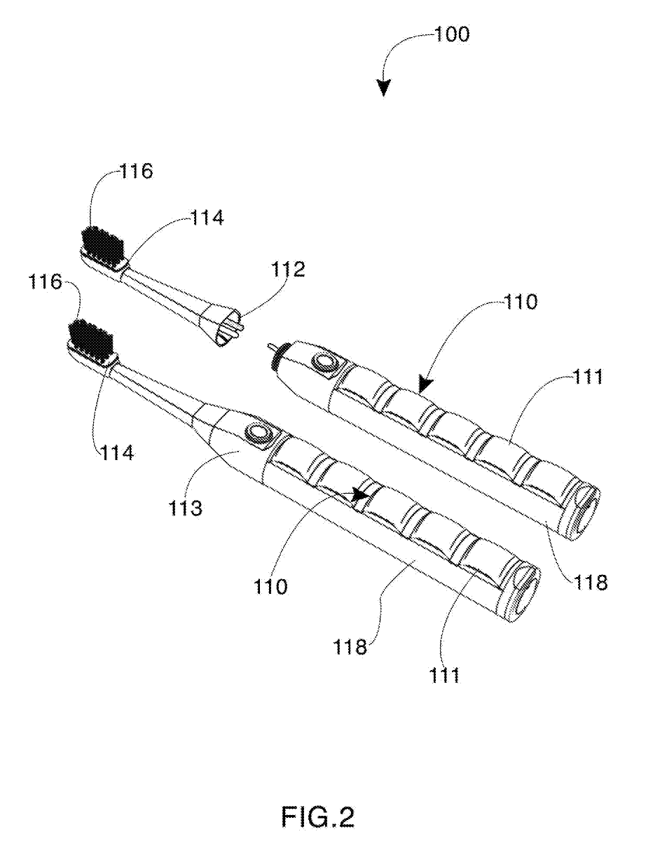

FIG. 2 shows a front perspective view of the electric tooth cleaning device 100 of FIG. 1, according to an embodiment of the present disclosure. The toothbrush 110 may include a housing 111 having an inner-capacity 112 defined by an outer-shell 113, the housing 111 further including a handle-end 118 and a brush-end 114. As shown, the brush-end 114 may include a plurality of dispensing apertures 115 (FIG. 3) and a plurality of bristles 116 thereon. Preferably, the brush-end 114 may be removeable or interchangeable to allow for replacement of the brush-end 114 of the housing 111.

FIG. 3 shows a front perspective view of the electric tooth cleaning device 100 of

FIG. 1, according to an embodiment of the present disclosure. As shown, the cartridge-compartment 130 may be disposed within the inner-capacity 112 of the housing 111. A cartridge-door 140 may be located on the outer-shell 113 of the housing 111 and configured to provide access to the cartridge-compartment 130. The cartridge-door 140 may include a latch 142 for locking the cartridge-door 140 to the outer-shell 113 of the housing 111. Further, a conduit 150 disposed within the inner-capacity 112 and may be connected to the dispensing apertures 115 at a first conduit-end 152.

At least one cartridge 160 may be provided for removable placement into the cartridge-compartment 130. The cartridge-shell 164 may be constructed from a pliable material. In one embodiment, the pliable material may be rubber. In another embodiment, the cartridge-shell 164 may include accordion folds along a length thereof. The at least one cartridge 160 may include a cartridge inner-capacity 162 defined by a cartridge-shell 164 and a toothcare-composition 166 housed within the cartridge inner-capacity 162. Different examples of the toothcare-composition 166 may include toothpaste, tooth whitening pastes, etc. The toothpaste may include different flavors. The at least one cartridge 160 may include a first cartridge-end 161 and a second cartridge-end 163; the first cartridge-end 161may be configured for attachment to the conduit 150 at a second conduit-end 154.

FIG. 4 shows a front perspective view of the electric tooth cleaning device 100 of FIG. 1, according to an embodiment of the present disclosure. The toothbrush-actuator 120 may be disposed within the inner-capacity 112 of the housing 111, the tooth-brush actuator 120 being connected to the brush-end 114 and configured to selectively move the brush-end 114 (FIG. 3). The toothbrush-actuator 120 may include a toothbrush-motor, a first-gear, a second-gear, a cam, and a connecting-rod.

Further, the cartridge-actuator 170 may be disposed within the inner-capacity 112 of the housing 111. The cartridge-actuator 170 may include a cartridge-plunger 172 being configured to manipulate the second cartridge-end 163 to dispense at least one a portion of the toothcare-composition 166 from the first cartridge-end 161 into the conduit 150. Further, the cartridge-actuator 170 may include a cartridge-motor 174 in communication with the cartridge-plunger 172. The toothcare-composition 166 may flow through the conduit 150 and dispense through the dispensing-apertures 115 (FIG. 3) of the brush-end 114 (FIG. 3). The cartridge-plunger 172 may include a plunger-plate 171 and a plunger-piston 173, and the cartridge-motor 174 may be configured to actuate movement of the plunger-plate 171 along the plunger-piston 173.

As above, the cartridge-shell 164 may be constructed from a pliable material. Preferably, the cartridge-plunger 172, aided by the cartridge-motor, may be configured to push the at least one cartridge 160 and collapse the pliable material to push the toothcare-composition 166 out through the cartridge-shell 164 into the conduit 150 (FIG. 3).

FIG. 5 shows a front perspective view of the electric tooth cleaning device 100 of FIG. 1, according to an embodiment of the present disclosure. The user-interface 180 may be located on the outer-shell 113 of the housing 111, the user-interface 180 being configured to selectively activate at least one of the toothbrush-actuator 120 (FIG. 4) and the cartridge-actuator 150 (FIG. 4). Preferably, the user-interface 180 may include a slidable-switch 181. The slideable-switch 181 may be movable between at least four positions 182. One of the at least four positions 182 may turn off the at least one power source 190, another one of the at least four positions 182 may activate the cartridge-actuator 150 (FIG. 4), and another one of the at least four positions 182 may activate the toothbrush-actuator 120 (FIG. 4). Further, as above, the cartridge-door 140 may include the latch 142 (FIG. 3) for locking the cartridge-door 140 to the outer-shell 113 of the housing 111. Preferably, the latch 142 (FIG. 2) may be in communication with the user-interface. In this embodiment, another one of the at least four positions 182 may activate the latch 142 (FIG. 3) to release.

Further, as shown, the electric tooth cleaning device 100 may include a brush-end cover 106 to prevent contamination of bacteria on the brush-end 114 of the brush-end 114. A strap 107 may be attachable to the outer-shell 113 of the housing 111. The strap 107 may be particularly useful for providing a secondary means of holding the toothbrush 110, which may be of use to users such as the elderly or disabled. Further, a charging-stand 108 may be provided and configured to charge the at least one power source. Preferably, the charging-stand 108 may include an LED light indicator 109 to provide indication means of the charging state of the electric tooth cleaning device 100.

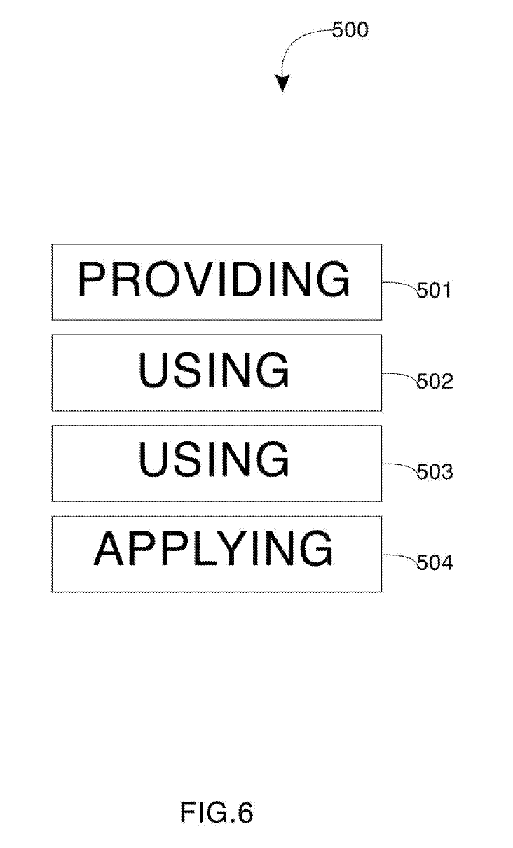

FIG. 6 is a flow diagram illustrating a method of using an electric tooth cleaning device 600, according to an embodiment of the present disclosure. As illustrated, the method of using an electric tooth cleaning device 600 may include the steps of: providing 601 the electric tooth cleaning device as above; using 602 the user-interface to activate the cartridge-actuator to dispense the at least the portion of the toothcare-composition through the dispensing-apertures; using 603 the user-interface to activate the toothbrush-actuator to move the brush-end; and applying 604 the at least the portion of the toothcare-composition to teeth of a user via the plurality of bristles.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for use of electric tooth cleaning device 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An electric tooth cleaning device comprising:
a toothbrush including a housing having an inner-capacity defined by an outer-shell, the housing further including a handle-end and a brush-end, the brush-end including a plurality of dispensing apertures and a plurality of bristles thereon;
a toothbrush-actuator disposed within the inner-capacity of the housing, the tooth-brush actuator being connected to the brush-end and configured to selectively move the brush-end;
a cartridge-compartment disposed within the inner-capacity of the housing;
a cartridge-door located on the outer-shell of the housing, the cartridge-door configured to provide access to the cartridge-compartment;
a conduit disposed within the inner-capacity, the being connected to the dispensing apertures at a first conduit-end;
at least one cartridge for removable placement into the cartridge-compartment, the at least one cartridge including a cartridge inner-capacity defined by a cartridge-shell and a toothcare-composition housed within the cartridge inner-capacity, the at least one cartridge further including a first cartridge-end and a second cartridge-end and wherein the first cartridge-end is configured for attachment to the conduit at a second conduit-end;
a cartridge-actuator disposed within inner-capacity of the housing, the cartridge-actuator including a cartridge-plunger being configured to manipulate the second cartridge-end to dispense at least one a portion of the toothcare-composition from the first cartridge-end into the conduit;
a user-interface located on the outer-shell of the housing, the user-interface being configured to selectively activate at least one of the toothbrush-actuator and the cartridge-actuator; and
at least one power-source disposed within the housing, the at least one power source configured to supply power to the toothbrush-actuator and the cartridge-actuator.

2. The electric tooth cleaning device of claim 1, wherein the cartridge-shell is constructed from a pliable material.

3. The electric tooth cleaning device of claim 2, wherein the pliable material is rubber.

4. The electric tooth cleaning device of claim 1, wherein the cartridge-shell includes accordion folds along a length thereof.

5. The electric tooth cleaning device of claim 1, wherein the cartridge-actuator includes a cartridge-motor in communication with the cartridge-plunger.

6. The electric tooth cleaning device of claim 5, wherein the cartridge-plunger includes a plunger-plate and a plunger-piston, and wherein the cartridge-motor is configured to actuate movement of the plunger-plate along the plunger-piston.

7. The electric tooth cleaning device of claim 1, wherein the user-interface includes a slidable-switch.

8. The electric tooth cleaning device of claim 7, wherein the slidable-switch is movable between at least four positions.

9. The electric tooth cleaning device of claim 8, wherein the one of the at least four positions turns off the power source.

10. The electric tooth cleaning device of claim 8, wherein the another one of the at least four positions activates the cartridge-actuator.

11. The electric tooth cleaning device of claim 8, wherein the another one of the at least four positions activates the toothbrush-actuator.

12. The electric tooth cleaning device of claim 1, wherein the cartridge-door includes a latch for locking the cartridge-door to the outer-shell of the housing.

13. The electric tooth cleaning device of claim 1, wherein the latch is in communication with the user-interface.

14. The electric tooth cleaning device of claim 8, wherein another one of the at least four positions activates the latch to release.

15. The electric tooth cleaning device of claim 1, further comprising a brush-end cover.

16. The electric tooth cleaning device of claim 1, further comprising a strap attachable to the outer-shell of the housing.

17. The electric tooth cleaning device of claim 1, further comprising a charging-stand configured to charge the at least one power source.

18. The electric tooth cleaning device of claim 1, wherein the charging-stand includes an LED light indicator.

19. An electric tooth cleaning device comprising:
a toothbrush including a housing having an inner-capacity defined by an outer-shell, the housing further including a handle-end and a brush-end, the brush-end including a plurality of dispensing apertures and a plurality of bristles thereon;
a toothbrush-actuator disposed within the inner-capacity of the housing, the tooth-brush actuator being connected to the brush-end and configured to selectively move the brush-end;
a cartridge-compartment disposed within the inner-capacity of the housing;
a cartridge-door located on the outer-shell of the housing, the cartridge-door configured to provide access to the cartridge-compartment;
a conduit disposed within the inner-capacity, the being connected to the dispensing apertures at a first conduit-end;
at least one cartridge for removable placement into the cartridge-compartment, the at least one cartridge including a cartridge inner-capacity defined by a cartridge-shell and a toothcare-composition housed within the cartridge inner-capacity, the
at least one cartridge further including a first cartridge-end and a second cartridge-end and wherein the first cartridge-end is configured for attachment to the conduit at a second conduit-end;
a cartridge-actuator disposed within inner-capacity of the housing, the cartridge-actuator including a cartridge-plunger being configured to manipulate the second cartridge-end to dispense at least one a portion of the toothcare-composition from the first cartridge-end into the conduit;
a user-interface located on the outer-shell of the housing, the user-interface being configured to selectively activate at least one of the toothbrush-actuator and the cartridge-actuator;
at least one power-source disposed within the housing, the at least one power source configured to supply power to the toothbrush-actuator and the cartridge-actuator;
a brush-end cover;
a strap attachable to the outer-shell of the housing; and
a charging-stand configured to charge the at least one power source; and
wherein the cartridge-shell is constructed from a pliable material;
wherein the pliable material is rubber;
wherein the cartridge-shell includes accordion folds along a length thereof;
wherein the cartridge-actuator includes a cartridge-motor in communication with the cartridge-plunger;
wherein the cartridge-plunger includes a plunger-plate and a plunger-piston, and
wherein the cartridge-motor is configured to actuate movement of the plunger-plate along the plunger-piston;
wherein the movement of the plunger-plate along the plunger-piston pushes the second cartridge-end and causes the second cartridge-end to substantially collapse into the first cartridge-end;
wherein the toothbrush-actuator includes a toothbrush-motor, a first-gear, a second-gear connected to the first-gear, and a connecting-rod connecting the second-gear and the brush-end of housing;
wherein the user-interface includes a slidable-switch;
wherein the slidable-switch is movable between at least four positions;
wherein the one of the at least four positions turns off the power source;
wherein the another one of the at least four positions activates the cartridge-actuator;
wherein the another one of the at least four positions activates the toothbrush-actuator;
wherein the cartridge-door includes a latch for locking the cartridge-door to the outer-shell of the housing;
wherein the latch is in communication with the user-interface;
wherein another one of the at least four positions activates the latch to release; and
wherein the charging-stand includes an LED light indicator.

20. A method of using an electric tooth cleaning device, the method comprising the steps of:
providing an electric tooth cleaning device including:
a toothbrush including a housing having an inner-capacity defined by an outer-shell, the housing further including a handle-end and a brush-end, the brush-end including a plurality of dispensing apertures and a plurality of bristles thereon;
a toothbrush-actuator disposed within the inner-capacity of the housing, the tooth-brush actuator being connected to the brush-end and configured to selectively move the brush-end;
a cartridge-compartment disposed within the inner-capacity of the housing;
a cartridge-door located on the outer-shell of the housing, the cartridge-door configured to provide access to the cartridge-compartment;
a conduit disposed within the inner-capacity, the being connected to the dispensing apertures at a first conduit-end;
at least one cartridge for removable placement into the cartridge-compartment, the at least one cartridge including a cartridge inner-capacity defined by a cartridge-shell and a toothcare-composition housed within the cartridge inner-capacity, the at least one cartridge further including a first cartridge-end and a second cartridge-end and wherein the first cartridge-end is configured for attachment to the conduit at a second conduit-end;
a cartridge-actuator disposed within inner-capacity of the housing, the cartridge-actuator including a cartridge-plunger being configured to manipulate the second cartridge-end to dispense at least one a portion of the toothcare-composition from the first cartridge-end into the conduit;
a user-interface located on the outer-shell of the housing, the user-interface being configured to selectively activate at least one of the toothbrush-actuator and the cartridge-actuator; and
at least one power-source disposed within the housing, the at least one power source configured to supply power to the toothbrush-actuator and the cartridge-actuator;
using the user-interface to activate the cartridge-actuator to dispense the at least said portion of the toothcare-composition through the dispensing-apertures;
using the user-interface to activate the toothbrush-actuator to move the brush-end; and
applying the at least said portion of the toothcare-composition to teeth of a user via the plurality of bristles.
